(19) United States
(12) Patent Application Publication
(10) Pub. No.: US 2008/0204373 A1
(43) Pub. Date: Aug. 28, 2008

(54) R-PORT ASSEMBLY FOR VIDEO SIGNAL FORMAT CONVERSION

(76) Inventors: Leroy SUTTON, Wheeling, IL (US); Dan Chin, Lincolnwood, IL (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 12/038,539

(22) Filed: Feb. 27, 2008

Related U.S. Application Data
(60) Provisional application No. 60/891,901, filed on Feb. 27, 2007.

(51) Int. Cl. G09G 3/28

(52) U.S. Cl. 345/60

(57) ABSTRACT

The disclosure is directed to a display device, and more particularly, to a flat panel display (FPD) device with a color graphics array (CGA) port. An adapter includes a driver having a plurality of first input terminals, such as transition minimized differential signaling (TMDS) terminals, and a plurality of analog signal terminals. The adapter also includes an input assembly that includes a plurality of second input terminals configured to receive the CGA input signal from an external source. The second input terminals are selectively coupled to the first input terminals to transfer the CGA input signal from the external source to the driver.

### CROSS REFERENCE TO PRIOR APPLICATION

This application claims priority under 35 U.S.C. § 119(e) to U.S. Provisional Patent Application No. 60/891,901 filed on Feb. 27, 2007, which is hereby incorporated by reference in its entirety for all purposes as if fully set forth herein.

### BACKGROUND OF THE DISCLOSURE

1. Field of the Disclosure

The disclosure is directed to a display device, and more particularly, to a flat panel display (FPD) device with a color graphics array (CGA) port.

2. Related Art

A color graphics adapter was introduced in 1981 by IBM as the first color graphics card and the first color computer display standard for the IBM personal computer (PC). When IBM introduced the PC Advanced Technology (AT) and the Enhanced Graphics Adapter (EGA) in 1984, the price of color graphics cards dropped, making color graphic cards an attractive low-cost solution for entry-level non-AT PCs with CGA graphics. Although the popularity of color graphic adapters started to wane after a Video Graphics Array (VGA) standard became IBM's high-level solution and the EGA standard became IBM's entry-level solution in 1987, the color graphic adapters are still being used in certain industries, such as, for example, the console-based video gaming industry for casinos, and the like. The CGA standard uses various connectors, including a standard DE-9 connector, or the like, depending on applications.

Recent advances in flat panel display technology have made flat panel displays, such as LCD (liquid crystal display) or plasma displays, more affordable and, hence, more desirable for display devices such as gaming consoles (e.g., slot machines, video poker machines, and the like). Generally speaking, flat panel displays are lighter, less bulky, consume less power and capable of displaying more vivid and aesthetically-pleasing graphics than cathode ray tube (CRT) displays. In order to receive a video signal from an external video signal source (e.g., a graphics card), the flat panel display devices are typically equipped with a VGA connector, which is also known as an RGB connector, D-sub 15, mini sub D15 and mini D15. Moreover, larger numbers of flat panel displays on the market are often equipped with a digital visual interface (DVI) connector. However, flat panel display devices on the market are often not equipped with a CGA connector. Thus, in order to display a CGA signal on a flat panel display, the CGA signal needs to be converted from a CGA signal to a DVI or VGA signal, or an additional CGA to DVI or CGA to VGA adaptor is required.

Accordingly, there is a need for a simple, reliable and cost-effective solution to allow a flat panel display device to receive and display a CGA video input signal.

### SUMMARY OF THE DISCLOSURE

The embodiments of the invention meet the foregoing needs and allow a flat panel display (FPD) device to receive a CGA input signal and display an image based on the CGA input signal. A CGA connector may be integrated with the FPD and selectively interconnected the pins of the CGA connector to the video signal input terminals of the FPD, which eliminates a need for converting the CGA input signal to a DVI or VGA input signal or adding an CGA to DVI or CGA to VGA adaptor and other advantages apparent from the discussion herein.

Accordingly, in one aspect of the disclosure, a display device for receiving a color graphics array (CGA) input signal and displaying an image on a display based on the CGA input signal includes a driver comprising a plurality of first input terminals, wherein the first input terminals comprise a plurality of transition minimized differential signaling (TMDS) terminals and a plurality of analog signal terminals, and an input assembly including a plurality of second input terminals configured to receive the CGA input signal from an external source wherein, the plurality of second input terminals are selectively coupled to the plurality of first input terminals to transfer the CGA input signal from the external source to the driver.

The display device may be a flat panel display. The display device may be at least one of a liquid crystal display (LCD), a plasma display, an organic light-emitting diode display (OLED), a light emitting diode display (LED), an electroluminescent display (ELD), a surface-conduction electron-emitter display (SED), a field emission display (FED) and a nano-emissive display (NED). The CGA input signal may include at least one of a red input signal, a green input signal, a blue input signal, a vertical sync input signal and a horizontal sync input signal. The plurality of TMDS terminals may include a vertical sync analog input terminal coupled to said vertical sync input terminal. The plurality of second input terminals may include a red input terminal configured to receive a red input signal, a green input terminal configured to receive a green input signal, a blue input terminal configured to receive a blue input signal, a vertical sync input terminal configured to receive a vertical sync input signal, and a horizontal sync input terminal configured to receive a horizontal sync input signal. The plurality of analog terminals may include a red analog input terminal coupled to said red input terminal, a green analog input terminal coupled to said green input, a blue analog input terminal coupled to said blue input terminal, and a horizontal sync analog input terminal coupled to said horizontal sync input terminal. The plurality of analog terminals may include an analog ground return terminal coupled to a ground. The input assembly may be an R-port assembly that includes a CGA input connector. The driver may include a circuit board configured such that the first terminals are arranged on an edge portion of the circuit board, and at least one third input terminal is arranged adjacent to the first terminals and coupled to a ground. The input assembly may further include a main body arranged adjacent to the edge of the circuit board; and a plurality of pins attached to the main body, each of the plurality of pins being arranged in parallel to each other. The external source may include a CGA output connector configured to engage the CGA input connector.

According to another aspect of the disclosure, an assembly structure is configured for receiving a color graphic array (CGA) signal via signal terminals, wherein the signal terminals include a plurality of analog terminals and a plurality of transition minimized differential signaling (TMDS) terminals. The assembly includes a plurality of first terminals selectively coupled to the plurality of analog terminals, and at least one second terminal selectively coupled to at least one of the plurality of transition minimized differential signaling (TMDS) terminals.

The plurality of analog terminals may include at least one of an analog red terminal, an analog green terminal, an analog blue terminal, an analog vertical sync terminal and a horizontal sync terminal, and at least one of the plurality of TMDS terminals may include an analog horizontal sync terminal. The plurality of first terminals may include a red terminal connectable to the analog red terminal, a green terminal connectable to the analog green terminal, a blue terminal connectable to the analog blue terminal, and a horizontal sync terminal connectable to the analog horizontal sync terminal. The second terminal may include a vertical sync terminal connectable to the analog vertical sync terminal. A display device may include the assembly structure. A CGA signal source device may include the assembly structure as well.

According to another aspect of the disclosure, a method for establishing a color graphics array (CGA) interface for coupling a display device and a CGA signal source device, wherein the CGA signal is transmitted across a plurality of analog terminals and a plurality of transition minimized differential signaling (TMDS) terminals, includes attaching an assembly device to one of a display device and signal source device, the assembly device comprising a plurality of assembly terminals, and selectively coupling the plurality of assembly terminals to the plurality of analog terminals and at least one of the plurality of TMDS terminals.

The plurality of analog terminals may include at least one of an analog red terminal, an analog green terminal, an analog blue terminal, an analog vertical sync terminal, and a horizontal sync terminal. The plurality of TMDS terminals may include at least one analog horizontal sync terminal. The plurality of R-port terminals may include at least one of a red terminal, a green terminal, a blue terminal, a horizontal sync terminal, and a vertical sync terminal. The step of selectively connecting comprises the steps may include connecting a red assembly terminal to an analog red terminal, connecting a green assembly terminal to an analog green terminal, connecting a blue assembly terminal to an analog blue terminal, connecting a vertical sync assembly terminal to an analog vertical sync terminal, and connecting a horizontal sync assembly terminal to an analog horizontal sync terminal. The method may also include removing an existing port from one of the display device and the signal source device prior to attaching the assembly device thereto, where the existing port includes a plurality of terminals selectively connected to the plurality of analog terminals and the plurality of TMDS terminals. The existing port may include a digital visual interface (DVI) connector.

Additional features, advantages, and embodiments of the disclosure may be set forth or apparent from consideration of the following detailed description, drawings, and claims. Moreover, it is to be understood that both the foregoing summary of the disclosure and the following detailed description are exemplary and intended to provide further explanation without limiting the scope of the disclosure as claimed.

### BRIEF DESCRIPTION OF THE DRAWINGS

The accompanying drawings, which are included to provide a further understanding of the disclosure, are incorporated in and constitute a part of this specification, illustrate exemplary embodiments of the disclosure and together with the detailed description serve to explain the principles of the disclosure. No attempt is made to show structural details of the disclosure in more detail than may be necessary for a fundamental understanding of the disclosure and the various ways in which it may be practiced. In the drawings:

FIG. 1 shows a flat panel display (FPD) device;

FIG. 2 shows a plurality of video signal input terminals arranged at an edge portion of a driving circuit board of the FPD device of FIG. 1;

FIG. 3 shows a CGA input connector attached to the driving circuit board of FIG. 2, constructed according to the principles of the disclosure;

FIG. 4 shows a circuit schematic of interconnection between the CGA input connector of FIG. 3 and the video signal input terminals of the driving circuit board of FIGS. 2 and 3, constructed according to the principles of the disclosure;

FIG. 5 shows the FPD device of FIG. 1, configured with the CGA input connector of FIG. 3, constructed according to the principles of the disclosure;

FIG. 6 shows a flowchart describing a process for establishing a CGA interface in the FPD device of FIG. 1, constructed according to the principles of the disclosure; and

FIG. 7 shows a CGA input connector attached to a driving circuit according to principles of the invention.

### DETAILED DESCRIPTION OF THE DISCLOSURE

The embodiments of the disclosure and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the disclosure. The examples used herein are intended merely to facilitate an understanding of ways in which the disclosure may be practiced and to further enable those of skill in the art to practice the embodiments of the disclosure. Accordingly, the examples and embodiments herein should not be construed as limiting the scope of the disclosure, which is defined solely by the appended claims and applicable law. Moreover, it is noted that like reference numerals represent similar parts throughout the several views of the drawings.

As mentioned above, the CGA standard is being superseded by newer video standards, such as VGA and DVI. However, many flat panel display (FPD) devices on the market are not equipped with a CGA connector. Moreover, the CGA video standard is still being used in certain industries, such as, for example, the video gaming industry for casinos and the like. As flat panel display devices become used in the video-gaming industry, it is necessary to adapt them to CGA-based gaming consoles (e.g., video poker and slot machines and the like). Typically, the CGA video signal includes analog component (red, green, blue, horizontal sync and vertical sync) video signals.

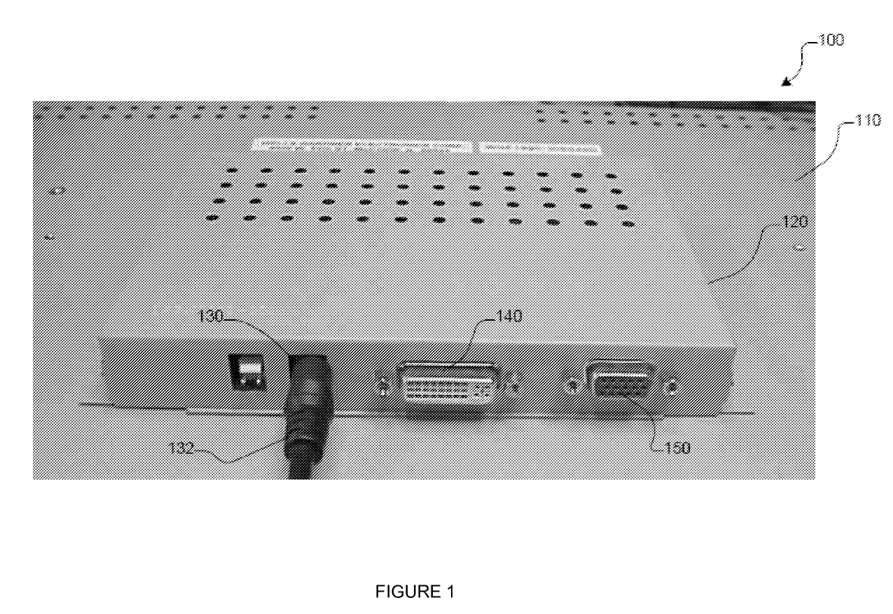

FIG. 1 shows a rear surface side 110 of an FPD device 100. According to the exemplary embodiment of the disclosure, the FPD device 100 is an LCD device. However, as the skilled artisan will readily recognize, without departing from the scope and/or spirit of the disclosure, the FPD device 100 may be any one, or combination of the following: a liquid crystal display (LCD), a plasma display, an organic light-emitting diode display (OLED), a light emitting diode display (LED), an electroluminescent display (ELD), a surface-conduction electron-emitter display (SED), a field emission display (FED), a nano-emissive display (NED), or any other display device capable of manifesting an image signal.

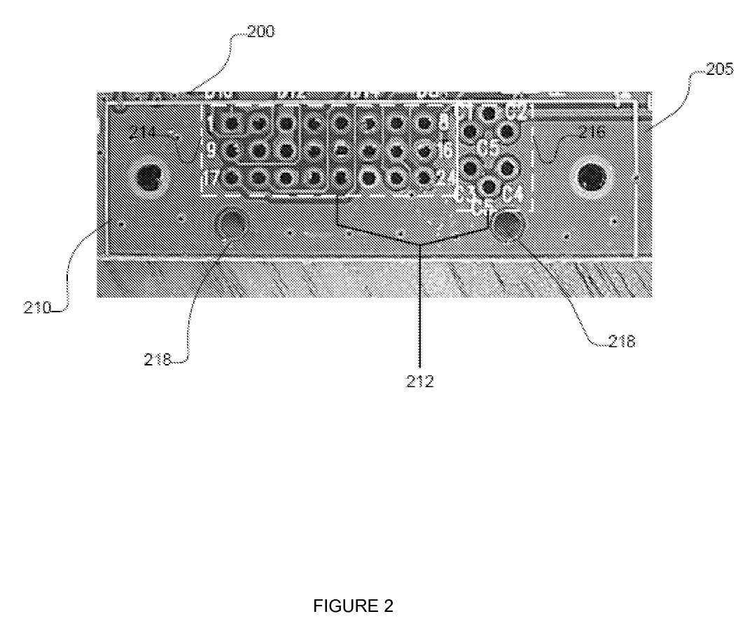

As shown, the FPD device 100 is equipped with a power cord plug receiver 130 configured to receive a power cord plug 132, a digital visual interface (DVI) port 140 and a video graphics array (VGA) port 150. The DVI port 140 and the VGA port 150 are provided to receive a video signal from an external video signal source (not shown), such as, for example, but not-limited to, a personal computer, a workstation computer, a gaming computer, or the like. The DVI port 140 and the VGA port 150 may be connected to a driving circuit 200 (shown in FIG. 2), which may be mounted on the rear surface 100 of the FPD device 100 and covered by a rear cover 120.

The DVI connector 140 may contain a plurality of pins and/or pin receptacles configured to receive a plurality of digital video signals from an external signal source and forward the digital signals to corresponding terminals provided on the driving circuit 200. While the configuration of the plurality of pins and/or receptacles in the DVI port 140 may be based on a PanelLink serial format, which uses Transition Minimized Differential Signaling (TMDS), the configuration of the pins and/or receptacles in the DVI port 140 may also include a plurality of pins and/or pin receptacles configured to receive analog signals having a format in the CGA or VGA standards.

The 15-pin VGA port 150, which is also known as an RGB connector, a D-sub 15, a mini sub D15 or a mini D15, may be configured to receive an analog video signal, including component video signals, such as, for example, a red signal, a green signal, a blue signal, a horizontal sync signal and a vertical sync signal. The received analog video signal may have any one of a plurality of display resolutions, as is known in the art, including, but not limited to, for example, 1920×1200, 2560×1600, 1920×1080, 1600×1200, 1920×1200, 1280×1024, 1440×900, 2048×1536, 3840×2400 or the like, which are received from the external video signal source.

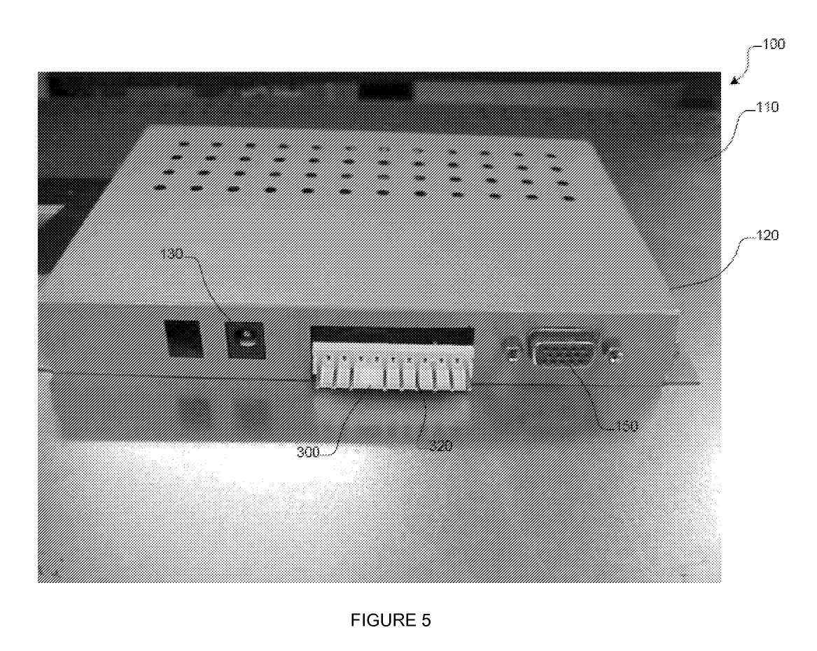

According to the principles of the invention, the DVI port 140 may be replaced by an R-port assembly 300 (shown in FIG. 5). The R-port assembly 300 may include a plurality of pins and/or receptacles configured to be selectively connectable to the video signal input terminals of the driving circuit 200. The R port assembly 300, including the plurality of pins and/or receptacles, may be configured to provide the FPD device 100 with a capability to receive a CGA signal and forward components of the received CGA signal to the driving circuit 200 for display of an image signal on the FPD device 110 based on the received CGA signal.

FIG. 2 shows a top view of an edge portion 210 of the driving circuit 200 of the FPD device 100. The driving circuit 200, which may be implemented in the form of a printed circuit board (PCB) 205, includes a plurality of video signal input terminals 212. According to an exemplary embodiment of the disclosure, the terminals 212 may be configured for interconnection with the pins and/or pin receptacles of the DVI port 140 shown in FIG. 1. For easier interconnection, the terminals 212 may be arranged proximate to a location where the DVI port 140 would normally be positioned. The video signal input terminals 212 may be configured, for example, for interconnection as described in Table 1, below. However, the below Table 1 is only one non-limiting example of possible terminal configurations for the input terminals 212. As a skilled artisan will readily recognize, other terminal configurations may be become apparent, depending on a particular application of the disclosure, without departing from the scope and/or spirit of the disclosure.

TABLE 1
Video Signal Input Terminal Configuration

| No. | Signal |
|---|---|
| 1 | Digital Red− (Link 1) |
| 2 | Digital Red+ (Link 1) |
| 3 | TMDS Data 2/4 Shield |
| 4 | Digital Green− (Link 2) |
| 5 | Digital Green+ (Link 2) |
| 6 | DDC Clock |
| 7 | DDC Data |
| 8 | Analog Vertical Sync |
| 9 | Digital Green− (Link 1) |
| 10 | Digital Green+ (Link 1) |
| 11 | TMDS Data 1/3 Shield |
| 12 | Digital Blue− (Link 2) |
| 13 | Digital Blue+ (Link 2) |
| 14 | +5 V |
| 15 | Ground |
| 16 | Hot Plug Detect |
| 17 | Digital Blue− (Link 1) |
| 18 | Digital Blue+ (Link 1) |
| 19 | TMDS Data 0/5 Shield |
| 20 | Digital Red− (Link 2) |
| 21 | Digital Red+ (Link 2) |
| 22 | Digital Clock+ |
| 23 | Digital Clock− |
| C1 | Analog Red |
| C2 | Analog Green |
| C3 | Analog Blue |
| C4 | Analog Horizontal Sync |
| C5 | Analog Ground Return |

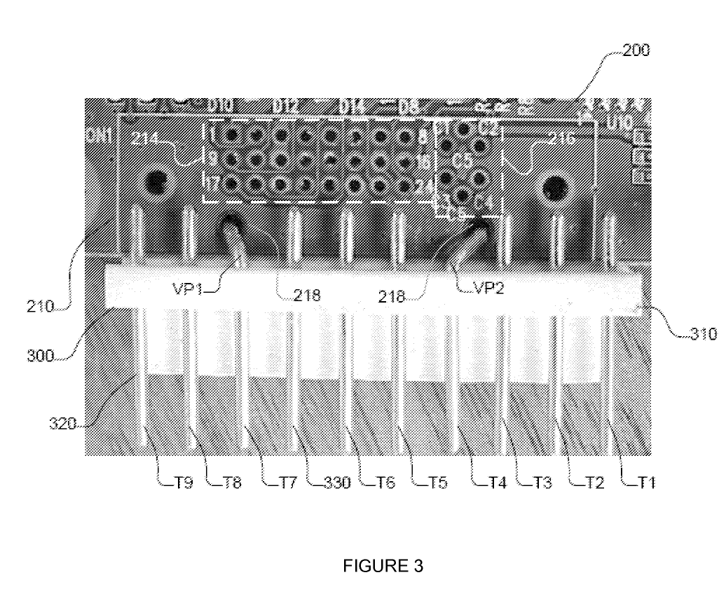

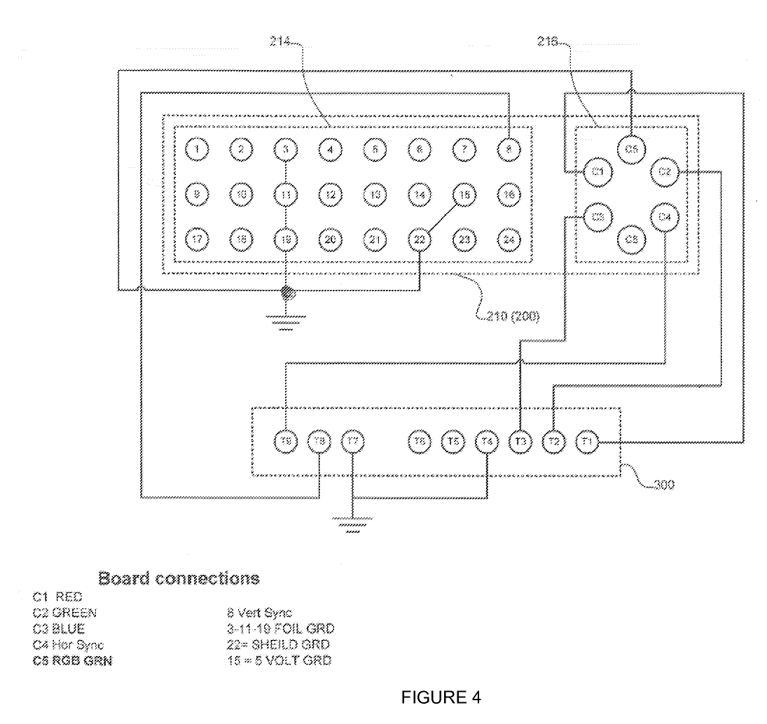

The video signal input terminals 212 may be categorically divided into Transition Minimized Differential Signaling (TMDS) terminals 214 and analog terminals 216. As shown in FIG. 4, the TMDS terminals 214 may be arranged in three linear rows, with each row having eight terminals. The analog terminals 216 may be arranged near to the TMDS terminals 214. Optionally, the PCB 205 may be configured to include a plurality of ground holes 218, which may be used for fixing corresponding video ports VP1 and VP2 (shown in FIG. 3) to the PCB 205.

Referring to Table 1, the TMDS terminals 214 may include a first terminal for receiving a Digital Red−(Link 1) signal, a second terminal for receiving a Digital Red+(Link 1) signal, a third terminal for receiving a TMDS Data 2/4 Shield signal, a fourth terminal for receiving a Digital Green−(Link 2) signal, a fifth terminal for receiving a Digital Green+(Link 2) signal, a sixth terminal for receiving a DDC Clock signal, a seventh terminal for receiving a DDC Data signal, an eighth terminal for receiving an analog Vertical Sync signal, a ninth terminal for receiving a Digital Green−(Link 1) signal, a tenth terminal for receiving a Digital Green+(Link 1) signal, an eleventh terminal for receiving a TMDS Data 1/3 Shield signal, a twelfth terminal for receiving a Digital Blue−(Link 2) signal, a thirteenth terminal for receiving a Digital Blue+(Link 2) signal, a fourteenth terminal for receiving a +5V signal, a fifteenth terminal for receiving a ground signal, a sixteenth terminal for receiving a hot plug detect signal, a seventeenth terminal for receiving a Digital Blue−(Link 1) signal, an eighteenth terminal for receiving a Digital Blue+(Link 1) signal, a nineteenth terminal for receiving a TMDS Data 0/5 Shield signal, a twentieth terminal for receiving a Digital Red−(Link 2) signal, a twenty-first terminal for receiving a Digital Red+(Link 2) signal, a twenty-second terminal for receiving a Digital Clock+signal, and a twenty-third terminal for receiving a Digital Clock−signal.

The analog terminals 216 may include a terminal C1 for receiving an analog red signal, a terminal C2 for receiving an analog green signal, a terminal C3 for receiving an analog blue signal, a terminal C4 for receiving an analog horizontal sync signal, and two terminals C5 for receiving an analog ground return for the analog red, green and blue signals.

FIG. 3 shows the R-port assembly 300 attached to the PCB 205. According to an exemplary embodiment of the disclosure, the R-port assembly 300 includes a main body 310 and a plurality of pins 320 arranged in parallel and extending through the main body 310 configured to receive and hold a plurality of pins T1 to T9. However, as the skilled artisan will readily recognize, without departing from the scope and/or spirit of the disclosure, the R-port assembly 300 may be a DE-9 connector or any other CGA port/connector capable of engaging another CGA connector and receiving a CGA video input signal therefrom. As shown, the R-port assembly 300 may include nine pins T1, T2, T3, T4, T5, T6, T7, T8 and T9 configured to engage a CGA connector.

Optionally, the R-port assembly 300 may include an additional pin 330 which may be arranged between the pins T6 and T7. The pin 330 may be omitted, for example, as shown in FIG. 5, so that a corresponding connector of a CGA input cable (not shown) may not be engaged to the R-port assembly 300 in an unintended direction, such as, for example, upside down. An exemplary and non-limiting pin configuration of the R-port assembly 300 is described in Table 2, below.

TABLE 2
CGA Port Pin Configuration

| Pin Number | Signal |
|---|---|
| T1 | Red |
| T2 | Green |
| T3 | Blue |
| T4 | Ground |
| T5 | N/A |
| T6 | N/A |
| T7 | Ground |
| T8 | Vertical Sync |
| T9 | Horizontal Sync |

As mentioned above, the CGA input signal may be an analog component video signal, including a component signals, such as, for example, a red component signal, a green component signal, a blue component signal, a horizontal sync component signal and/or a vertical sync component signal. To facilitate reception of the CGA input signal, the pins 320 of the R-port assembly 300 may be selectively interconnected to the terminals 212 (including the TMDS terminals 214 and analog terminals 216) of the driving circuit 200.

For example, FIG. 4 shows an exemplary circuit schematic of an interconnection between the plurality of pins 320 of the R-port assembly 300 and the terminals 212 (including the TMDS terminals 214 and analog terminals 216) of the driving circuit 200, constructed according to the principles of the disclosure. As mentioned above, the eighth terminal of the TMDS terminals 214 may be configured to receive the analog vertical sync signal from a corresponding video port. Thus, the eighth terminal of the TMDS terminals 214 may be connected to the pin T8 of the R-port assembly 300 for receiving the vertical sync signal therefrom. Further, each of the third, the eleventh, the fifteenth, the nineteenth and the twenty-second terminals may be connected to a ground, as described in greater detail below. Other terminals of the TMDS terminals 214 may not be connected to any of the pins 320 of the R-port assembly 300 as they may be configured to receive a plurality of non-CGA signals.

The analog terminals 216 may be selectively connected to the pins 320 of the R-port assembly 300. For example, the terminal C1 of the analog terminals 216 may be connected to the pin T1 of the R-port assembly 300 to receive a red signal therefrom. The terminal C2 of the analog terminals 216 may be connected to the pin T2 of the R-port assembly 300 to receive a green signal therefrom. The terminal C3 of the analog terminals 216 may be connected to the pin T3 of the R-port assembly 300 to receive a blue signal therefrom. The terminal C4 of the analog terminals 216 may be connected to the pin T9 of the R-port assembly 300 to receive the horizontal sync signal therefrom. The terminal C5 of the analog terminals 216 may be connected to the ground.

Furthermore, as shown in FIG. 4, and noted above, among the TMDS terminals 214, the third terminal for receiving the TMDS Data 2/4 Shield signal, the eleventh terminal for receiving the TMDS Data 1/3 Shield signal, the fifteenth terminal for receiving the ground signal, the nineteenth terminal for receiving the TMDS Data 0/5 Shield signal and the twenty second terminal for receiving the Digital Clock+signal may be connected to a ground for a common signal ground at end of a cable. The pins T4 and T7 of the R-port assembly 300 may be also connected to the ground. Although various components and terminals have been described as being connected, it is understood that these components and/or terminals may be coupled as well, such as by an indirect connection through one or more other components.

According to an aspect of the disclosure, the pins T4 and T7 may be bent toward the driving circuit board 200, as shown, for example, in FIG. 3 at VP1 and VP2, and inserted into the ground holes 218 to form direct electrical contact with the driving circuit 200, while substantially preventing the R-port assembly 300 from moving from its intended location.

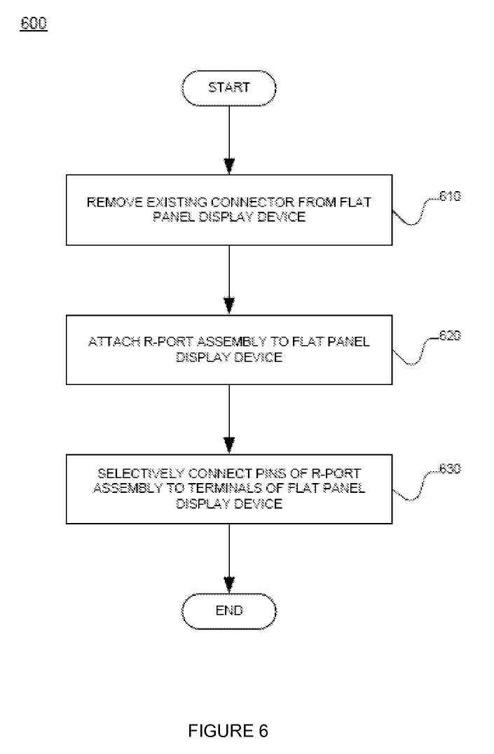

FIG. 6 shows a flowchart 600 describing a process for establishing a CGA interface in a display device, constructed according to the principles of the disclosure. At step 610, it may be necessary to remove an existing connector, such as the DVI port 140 shown in FIG. 1, from the FPD device 100. However, step 610 may not be necessary if no connector is attached to the FPD device 100. At step 620, the R-port assembly 300 may be attached to the FPD device 100. For example, as shown in FIG. 3, the R port 300 may be attached to the edge portion 210 of the driving circuit 200, and the pins T4 and T7 may be bent toward the driving circuit board 200 (as shown at VP1 and VP2) and inserted into the ground holes 218 to substantially prevent the R-port assembly 300 from moving from its intended location. At step 630, the pins 320 of the R-port assembly 300 may be selectively connected to the terminals 212 (including the TMDS terminals 214 and analog terminals 216) of the driving circuit 200 in the manner described above such that the FPD device 100 may be capable of displaying an image based on the analog video component signals applied to the R-port assembly.

Thus, according to the disclosure, all of the analog video component signals applied to the R-port assembly 300 may be transferred to the video signal input terminals 214, 216, enabling the FPD device 100 to display an image based on the received CGA video input signal. Also, as shown in FIG. 5, the FPD device 100 may be equipped with the R-port assembly 300 configured to engage a CGA connector, thereby eliminating the necessity for a CGA to DVI adaptor. Accordingly, the disclosure provides a simple and cost-effective solution for allowing a FPD device 100 to receive and display a CGA video input signal.

While the disclosure was described above with reference to establishing the interconnection with the FPD device 100 and the R-port assembly 300, the disclosure may equally be applied to establishing an interconnection between the R-assembly 300 and a signal source device, such as, for example, a digital versatile disc (DVD) player, a digital video recorder (DVR), a digital camcorder, a video card and the like, or any other signal source device equipped with a plurality of analog terminals and a plurality of TMDS terminals for outputting a video signal therefrom, without departing from the scope and/or spirit of the disclosure.

Furthermore, while the disclosure was described above with reference to physical interconnections between the TMDS terminals 214, analog terminals 216 and pins and/or pin receptacles in the R-port assembly 300, digital circuit equivalents for each of the interconnections may equally be used, without departing from the scope and/or spirit of the disclosure. For example, each of the TMDS terminals 214, analog terminals 216 and pins and/or receptacles in the R-port assembly 300 may be connectable to a thirty-seven by thirty-seven (37×37) digital multiplexer (not shown) that dynamically forms connections between the R-port assembly 300 and the driving circuit 200, under control of a computer program. The dynamically formed connections formed in the thirty-seven by thirty-seven multiplexer may be dynamically reconfigured on a basis of the computer program so that a signal other than a CGA input signal may be input and properly displayed on the FPD device. The computer program may be provided on a computer readable medium having code sections, that, when executed, cause the connection to be dynamically formed by the thirty-seven by thirty-seven multiplexer.

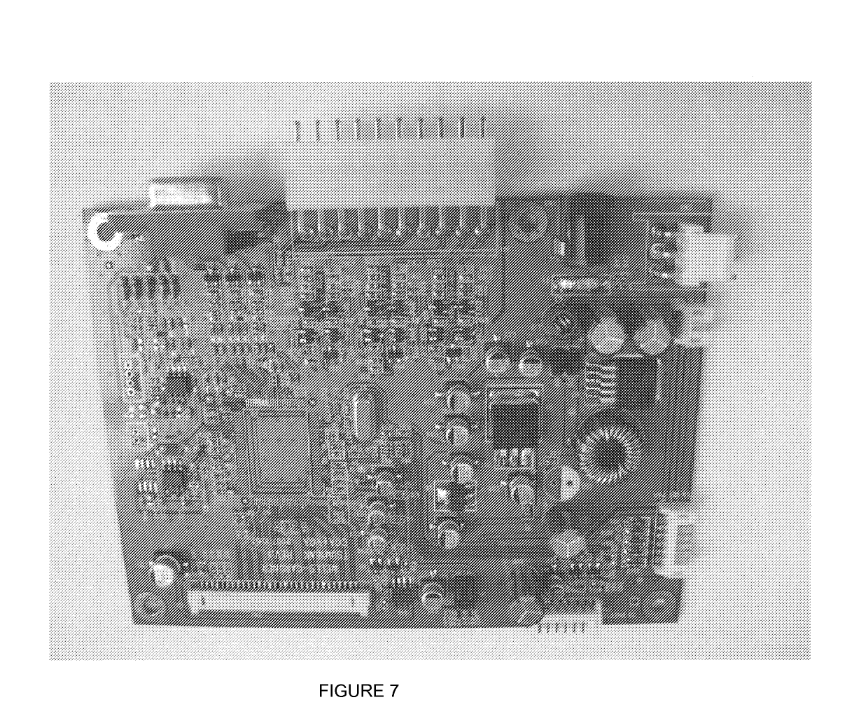

FIG. 7 shows a CGA input connector attached to a driving circuit according to principles of the invention.

While the disclosure has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the disclosure.

What is claimed is:

1. A display device for receiving a color graphics array (CGA) input signal and displaying an image on a display based on the CGA input signal, the display device comprising:
a driver comprising a plurality of first input terminals, wherein said first input terminals comprise a plurality of transition minimized differential signaling (TMDS) terminals and a plurality of analog signal terminals; and
an input assembly including a plurality of second input terminals configured to receive the CGA input signal from an external source, wherein said plurality of second input terminals are selectively coupled to said plurality of first input terminals to transfer the CGA input signal from the external source to the driver.

2. The display device of claim 1, wherein said display is a flat panel display.

3. The display device of claim 1, wherein said display is at least one of a liquid crystal display (LCD), a plasma display, an organic light-emitting diode display (OLED), a light emitting diode display (LED), an electroluminescent display (ELD), a surface-conduction electron-emitter display (SED), a field emission display (FED) and a nano-emissive display (NED).

4. The display device of claim 1, wherein the CGA input signal comprises at least one of a red input signal, a green input signal, a blue input signal, a vertical sync input signal and a horizontal sync input signal.

5. The display device of claim 4, wherein said plurality of TMDS terminals comprise a vertical sync analog input terminal coupled to said vertical sync input terminal.

6. The display device of claim 1, wherein said plurality of second input terminals comprises:
a red input terminal configured to receive a red input signal;
a green input terminal configured to receive a green input signal;
a blue input terminal configured to receive a blue input signal;
a vertical sync input terminal configured to receive a vertical sync input signal; and
a horizontal sync input terminal configured to receive a horizontal sync input signal.

7. The display device of claim 6, wherein said plurality of analog terminals comprise:
a red analog input terminal coupled to said red input terminal;
a green analog input terminal coupled to said green input;
a blue analog input terminal coupled to said blue input terminal; and
a horizontal sync analog input terminal coupled to said horizontal sync input terminal.

8. The display device of claim 1, wherein said plurality of analog terminals include an analog ground return terminal coupled to a ground.

9. The display device of claim 1, wherein said input assembly is an R-port assembly.

10. The display device of claim 9, wherein said R-port assembly comprises a CGA input connector.

11. The display device of claim 1, wherein said driver further comprises:
a circuit board configured such that said first terminals are arranged on an edge portion of said circuit board; and
at least one third input terminal arranged adjacent to the first terminals and coupled to a ground.

12. The display device of claim 11, wherein said input assembly further comprises:
a main body arranged adjacent to the edge of said circuit board; and
a plurality of pins attached to said main body, each of said plurality of pins being arranged in parallel to each other.

13. The display device of claim 1, wherein the external source comprises a CGA output connector configured to engage the CGA input connector.

14. An assembly structure configured for receiving a color graphic array (CGA) signal via signal terminals, wherein said signal terminals include a plurality of analog terminals and a plurality of transition minimized differential signaling (TMDS) terminals, the assembly comprising:
a plurality of first terminals selectively coupled to the plurality of analog terminals; and
at least one second terminal selectively coupled to at least one of the plurality of transition minimized differential signaling (TMDS) terminals.

15. The assembly structure of claim 14, wherein the plurality of analog terminals comprise at least one of an analog red terminal, an analog green terminal, an analog blue terminal, an analog vertical sync terminal and a horizontal sync terminal, and
wherein at least one of the plurality of TMDS terminals comprises an analog horizontal sync terminal.

16. The assembly structure of claim 15, wherein said plurality of first terminals comprises:
a red terminal connectable to the analog red terminal;
a green terminal connectable to the analog green terminal;
a blue terminal connectable to the analog blue terminal; and
a horizontal sync terminal connectable to the analog horizontal sync terminal, and
the second terminal comprises a vertical sync terminal connectable to the analog vertical sync terminal.

17. A display device including the assembly structure of claim 14.

18. A CGA signal source device including the assembly structure of claim 14.

19. A method for establishing a color graphics array (CGA) interface for coupling a display device and a CGA signal source device, wherein the CGA signal is transmitted across a plurality of analog terminals and a plurality of transition minimized differential signaling (TMDS) terminals, the method comprising the steps of:
attaching an assembly device to one of a display device and signal source device, the assembly device comprising a plurality of assembly terminals; and
selectively coupling the plurality of assembly terminals to the plurality of analog terminals and at least one of the plurality of TMDS terminals.

20. The method of claim 19, wherein the plurality of analog terminals include at least one of an analog red terminal, an analog green terminal, an analog blue terminal, an analog vertical sync terminal, and a horizontal sync terminal.

21. The method of claim 19, wherein the plurality of TMDS terminals comprises at least one analog horizontal sync terminal.

22. The method of claim 19, wherein the plurality of R-port terminals comprises at least one of a red terminal, a green terminal, a blue terminal, a horizontal sync terminal, and a vertical sync terminal.

23. The method of claim 19, wherein said step of selectively connecting comprises the steps of:
connecting a red assembly terminal to an analog red terminal;
connecting a green assembly terminal to an analog green terminal;
connecting a blue assembly terminal to an analog blue terminal;
connecting a vertical sync assembly terminal to an analog vertical sync terminal; and
connecting a horizontal sync assembly terminal to an analog horizontal sync terminal.

24. The method of claim 19, further comprising a step of removing an existing port from one of the display device and the signal source device prior to attaching the assembly device thereto, the existing port comprising a plurality of terminals selectively connected to the plurality of analog terminals and the plurality of TMDS terminals.

25. The method of claim 24, wherein the existing port is a digital visual interface (DVI) connector.
